(19) United States
(12) Patent Application Publication
(10) Pub. No.: US 2025/0330258 A1
(43) Pub. Date: Oct. 23, 2025

(54) LOW-LATENCY RADIO FREQUENCY SIGNAL CLASSIFICATION FOR ONLINE RF SENSING

(71) Applicant: ColdQuanta, Inc., Boulder, CO (US)

(72) Inventors: Pranav Gokhale, Chicago, IL (US); Caitlin Elizabeth Carnahan, Naperville, IL (US)

(21) Appl. No.: 19/184,133

(22) Filed: Apr. 21, 2025

Related U.S. Application Data
(60) Provisional application No. 63/637,288, filed on Apr. 22, 2024.

(51) Int. Cl. H04K 3/00

(52) U.S. Cl. CPC H04K 3/22; H04K 3/28

(57) ABSTRACT

Examples relate to the field of radio frequency (RF) signal processing such as classifying RF signals with low latency. The method involves receiving portions of an RF signal, transforming these portions into a time-resolved frequency representation using a continuous wavelet transform, and processing this representation with a recurrent neural network. The neural network modifies a neural network state incrementally to generate a classification output, which may include modulation classification, signal-to-noise ratio (SNR) classification, or jamming detection. The system achieves sub-millisecond inference latency through techniques such as model quantization and batch size optimization. Principal uses include real-time RF signal analysis and jamming detection, with applications in communication systems and environmental monitoring. The RF signal may be received from a quantum RF sensor based on Rydberg atoms, enabling broad frequency range detection.

### PRIORITY CLAIM

This application claims the benefit of priority to U.S. Provisional Patent Application Ser. No. 63/637,288, filed Apr. 22, 2024, which is incorporated by reference herein in its entirety.

### BACKGROUND

Radio frequency (RF) sensing generally refers to apparatus and techniques that can be used to detect and measure RF signals for various applications, such as communication systems, navigation, and environmental monitoring. As an illustrative but non-limiting example, the phrase “radio frequency signals” can refer to time varying electromagnetic signals having a frequency from an order of magnitude of about one kilohertz to hundreds of gigahertz (GHz). RF sensors can be configured to detect signals across a wide range of frequencies and intensities.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a flow diagram for an example comprising a method of processing radio frequency (RF) signals using a neural network.

FIG. 2 illustrates an example comprising a system for processing RF signals using a neural network.

FIG. 3, FIG. 4, and FIG. 5 illustrate graphs of a continuous wavelet transform (CWT) of a time-varying signal with varying values of a Gaussian envelope width, in accordance with illustrative examples.

FIG. 6 illustrates a graph of results for a modulation classification task from a neural network processing a time-resolved frequency representation of radio frequency signals, in accordance with illustrative examples.

FIG. 7, FIG. 8, FIG. 9 and FIG. 10 illustrate graphs of results for signal-to-noise classification tasks from a neural network processing a time-resolved frequency representation of radio frequency signals, in accordance with illustrative examples.

FIG. 11 illustrates a graph of results for classification tasks from a neural network processing a time-resolved frequency representation of radio frequency signals, in accordance with illustrative examples.

FIG. 12 illustrates a graph of results for various processor configurations to reduce inference latency in accordance with illustrative examples.

FIG. 13 illustrates generally an example of a block diagram of a computing machine upon which any one or more of the techniques discussed herein may be performed.

FIG. 14 illustrates an atomic level diagram of Rydberg transitions that can be used in a quantum radio frequency sensor in accordance with illustrative examples.

FIG. 15 shows illustrative examples of quantum radio frequency time series data.

FIG. 16 and FIG. 17 illustrate graphs of results for signal-to-noise classification tasks from a neural network processing a time-resolved frequency representation of quantum radio frequency sensed data, in accordance with illustrative examples.

### DETAILED DESCRIPTION

The present subject matter can include or use a machine learning approach applied to processing and classification of radio frequency (RF) signals. RF signals are associated with various applications, such as communication systems, navigation, or environmental monitoring. These signals can be complex and dynamic, especially in environments with high interference or noise. In one approach, predetermined algorithms can be used for detection or classification, but such an approach may not adapt well to changing conditions. The present subject matter can, for example, facilitate enhance detection or classification capability, such as in the presence of changing conditions, using machine learning techniques.

According to an example, the present subject matter can include or use a combination of continuous wavelet transform (CWT) and one or more recurrent neural network(s) (RNN) to process RF signals contemporaneously with receiving such signals (e.g., in “real time” or “near real time”). The CWT is a mathematical tool that transforms a signal from the time domain to a time-resolved frequency representation. This transformation allows the system to capture both time and frequency information, which facilitates analysis of signals that change rapidly over time. The CWT can be adjusted to balance time and frequency resolution, making it adaptable to different types of signals.

Once the RF signal is transformed into a time-resolved frequency representation, the time-resolved frequency representation can be processed by one or more recurrent neural network(s). RNNs are a type of neural network configured to handle sequential data (e.g., time series records). They are capable of maintaining a state that evolves over time, allowing them to capture temporal dependencies in the data. As an example, RNNs can process the transformed signal in time increments, modifying the RNN state at respective time steps. This incremental processing enables the RNN(s) to generate a classification output based on an evolving state of the network.

The classification output can include various types of information, such as modulation classification, signal-to-noise ratio (SNR) classification, or jamming detection, as illustrative but non-limiting examples. Modulation classification can include identifying the type of modulation used in the RF signal, which can aid identification or decoding of signal content. SNR classification can be used to assess a quality of the signal by comparing the strength of the target signal to the background noise. Jamming detection can be used to identify a presence of intentional interference, such as to facilitate maintaining of reliable communication in contested environments.

The present subject matter can be used to achieve low-latency processing, meaning that the techniques herein can be used to analyze signals contemporaneously with receiving them (e.g., detection, classification, or both). As an illustration, examples described herein can achieve sub-millisecond inference latency through techniques like model quantization and batch size optimization. The present subject matter can be embedded into hardware used in RF sensing environments such as airborne or terrestrial sensing environments for online analysis and decision making.

The present subject matter can be used with quantum RF sensors based on Rydberg atoms. Quantum RF sensors can detect signals across a wide spectrum, from low to high frequencies (e.g., Hz to GHz), and can be used to acquire high-resolution data. The present subject matter can process data from these sensors, enabling advanced RF signal analysis in quantum systems.

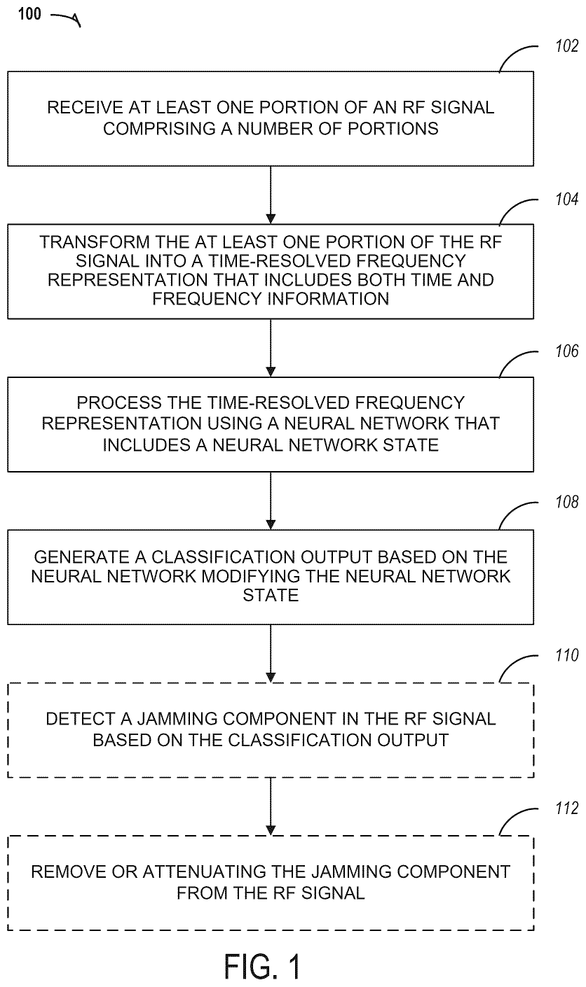

FIG. 1 illustrates a method 100 for processing radio-frequency (RF) signals using a neural network, in accordance with some examples.

Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of a device or system that implements the routine may perform functions at substantially the same time or in a specific sequence.

In an example, the method 100 may be performed on hardware (e.g., computing machine 1300) configured to provide a sub-millisecond inference latency. The hardware (e.g., computing machine 1300) may have one or more processor-specific optimizations applied to achieve a sub-millisecond inference latency. For example, the method 100 may use techniques such as model quantization and batch size optimization to achieve sub-millisecond inference latency.

In an example, the method 100 may begin at block 102, where the method 100 may receive at least one portion of an RF signal comprising a number of portions. The method 100 may receive an RF signal from an antenna structure (e.g., phased array, etc.). Other approaches for detection can be used. For example, the method 100 may receive an RF signal from a quantum RF sensor, such as a sensor based on a Rydberg atom. As an illustration, the method 100 may receive an RF signal having multiple RF tones spanning a frequency range of at least 100 GHz.

In an example, the method 100 may continue to block 104, where the method 100 may transform the at least one portion of the RF signal into a time-resolved frequency representation that includes both time and frequency information. Transforming the at least one portion of the RF signal may include performing a continuous wavelet transform (CWT) on the at least one portion of the RF signal. In an example, the time-resolved frequency representation includes a selectable Gaussian envelope width. For example, a value for the selectable Gaussian envelope width may be selected to favor improving time resolution of the time-resolved frequency representation over improving frequency resolution of the time-resolved frequency representation. Conversely, a value for the selectable Gaussian envelope width may be selected to favor improving frequency resolution of the time-resolved frequency representation over improving time resolution of the time-resolved frequency representation.

In an example, such as when the method 100 receives an RF signal at block 102 from a quantum RF sensor, then at block 104, the method 100 may obtain the time-resolved frequency representation from transitions between Rydberg energy states of the Rydberg atom.

In an example, the method 100 may continue to block 106, where the method 100 may process the time-resolved frequency representation using a neural network, such as one or more recurrent neural networks (RNNs). In an example, the neural network includes a neural network state, wherein the neural network processes the time-resolved frequency representation in time increments such that the neural network state is modified at respective time increments to provide a modified neural network state that is used by the neural network in a next respective time increment. In an example, the method 100 may process a selected number of time increments of the time-resolved frequency representation, corresponding to a partial duration of the RF signal, until at least one of: (1) a target classification accuracy is obtained (e.g., at block 108); or (2) a maximum number of time increments are processed.

In an example, the method 100 may continue to block 108, where the method 100 may generate a classification output (e. g., a modulation classification, a signal-to-noise ratio (SNR) classification, a jamming detection, or the like) based on the neural network modifying the neural network state over one or more time increments of processing of the time-resolved frequency representation, corresponding to at least some of the number of portions of the RF signal. In an example, the classification output may include a confidence parameter that increases in confidence as the neural network performs additional time increments of processing of the time-resolved frequency representation, corresponding to processing additional portions of the RF signal.

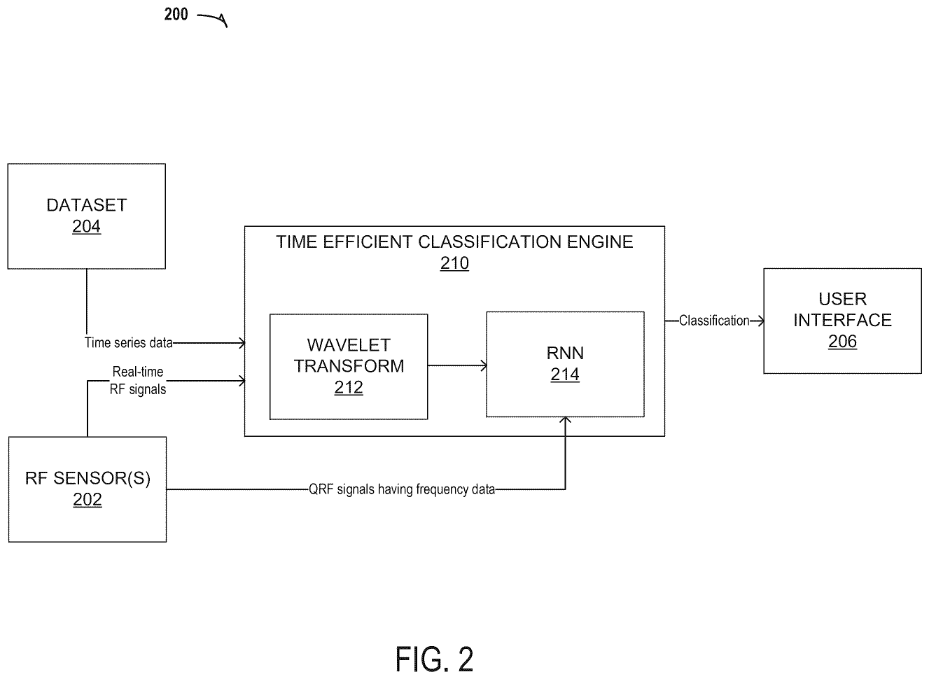

In an example, the method 100 may optionally continue to block 110, where the method 100 may detect a jamming component in the RF signal based on the classification output. As described below in FIG. 2, the method may detect (e.g., classify) a jamming component based on a jamming component in a training dataset.

In an example, the method 100 may optionally continue to block 112, where the method 100 may compensate for the jamming component, such as to remove or attenuate the jamming component from the RF signal.

FIG. 2 illustrates a schematic of a system 200 for processing RF signals using a neural network, in accordance with some examples. In an example, the system 200 comprises a low-latency classification model, time efficient classification engine 210 comprising wavelet transform 212 and a recurrent neural network (RNN 214), that provides inferences (e.g., classification outputs) more efficiently than a direct neural network implementation processing input (e.g., I/Q signal) data. In an example, the system 200 comprises one or more RF sensor 202, a dataset 204, and a user interface 206.

For example, the system 200 being “low latency” can refer to the system 200 or portions of the system 200 (e.g., the time efficient classification engine 210) being able to output a candidate classification in less time than a duration corresponding to a finite-length time-series record input to the system 200. As an example, an output classification can be made within a duration corresponding to a specified count of samples in the time-series record (e.g., within 10 samples, or within 100 samples, or within 1000 samples). Alternatively, or in addition, a latency can be specified as a scalar maximum duration between receiving a time-series record and outputting a candidate classification (e.g., less than one millisecond, or less than 500 microseconds, etc.).

In an example, the RF sensor 202 may detect RF signals in any suitable RF bandwidth (e.g., according to a bandwidth of the, and may transmit the detected signal to the time efficient classification engine 210 where the detected RF signal can be received. In an example, when the time efficient classification engine 210 receives the detected RF signal, the time efficient classification engine 210 may process the RF signal using any specified processing techniques, such as method 100 as described above in connection with FIG. 1. In an example, a classification output from the time efficient classification engine 210 may be validated (e.g., using a validation dataset, such as a portion of the dataset 204), and a classification accuracy may be determined. In an example, the classification (e.g., a signal strength such as signal-to-noise ratio, a signal modulation type, a carrier frequency, etc.) may be communicated to a user of the system 200, for example on the user interface 206. The classification output from the time efficient classification engine 210 may include a set of ordered pairs, such as an indication of the timestep or signal chunk, and a label referring to a value within the classification task (e.g., modulation classification). As a specific example which may be understood to be non-limiting, a classification output in classifying modulation schemes may include the following: {(1, QPSK), (2, BPSK), (3, QPSK), . . . }.

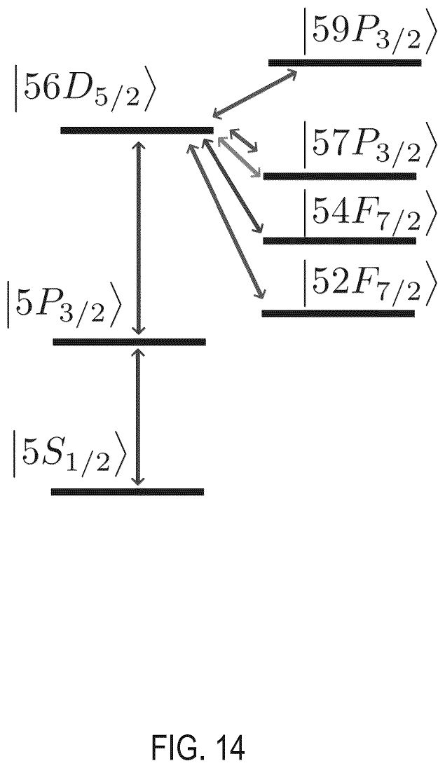

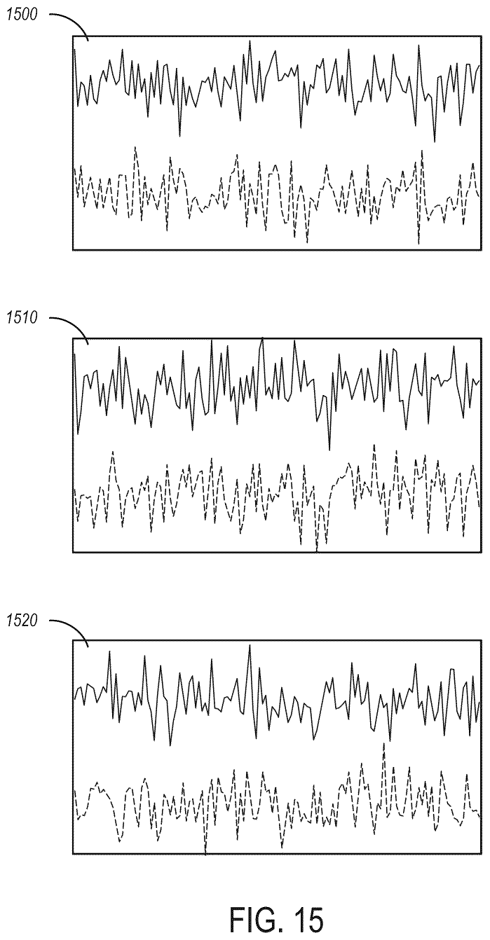

The RF sensor 202 may be any specified RF sensor or combination of multiple RF sensors. In an example, the RF sensor 202 may comprise an antenna structure (e.g., phased array, etc.). The subject matter described herein also comprises quantum RF sensor(s) (e.g., based on a Rydberg atom) for the RF sensor 202, as described below in connection with FIG. 14 and FIG. 15.

In an example, the dataset 204 may be input to the time efficient classification engine 210 as a training dataset and as a validation dataset. That is, the dataset 204 may be portioned such that a first subset of the data may be used for training the time efficient classification engine 210 and a different subset (such as a remainder of the data) may be used for validating the trained time efficient classification engine 210. In an example, the dataset 204 may include time series data, such as RF signals, where respective time series data may be labeled to include any specified information (e.g., for training the time efficient classification engine 210), such as a signal-to-noise ratio of the respective time series, a modulation type of the respective time series, or the like.

In an example, the dataset 204 may include examples of time series data that have one or more jamming signal components. That is, the dataset 204 may include a label as to whether jamming is present, indications of time(s) where jamming is present, frequencies which are being jammed, qualitative observations such as type(s) of jamming equipment based on a jamming profile, or the like.

In an example, the dataset 204 may include any suitable RF signals such as the simulated RF signals in the RadioML2016.10A dataset, available at the open-source code repository GitHub. The RadioML2016.10A dataset includes 220,000 simulated RF signals across 11 modulation modes, encompassing both digital (8 modes) and analog (3 modes) modulation types. Signals are represented as respective 2×128 arrays, encapsulating In-phase and Quadrature (I/Q) components across 128 time steps, with Signal-to-Noise Ratio (SNR) values ranging from −20 dB to +18 dB.

In an example, the dataset 204 may include simulated RF signals from a QRF sensor, as described below in connection with FIG. 14 and FIG. 15.

In an example, the dataset 204 may include time-varying signals having a variety of modulation patterns, different signal-to-noise (SNR) ratios, or any other specified attribute(s) that may be used to train the time efficient classification engine 210 to output a classification of the attribute(s). Training (including a validation phase) the time efficient classification engine 210 on the dataset 204 while not receiving RF signals from RF sensor 202. In an example, the time efficient classification engine 210 may be trained for any number of training cycles (“epochs”). In an example, the dataset 204 may be used for configuring the time efficient classification engine 210 to classify input signals.

In an example, the time efficient classification engine 210 may be a classification model that can perform classification of RF signals contemporaneously with receiving such signals (e.g., in “real time” or “near real time”) and can output the classification, such as to user interface 206. The time efficient classification engine 210 may include the wavelet transform 212 (or any other transformation to a time-frequency representation of an ingested signal) and one or more recurrent neural network(s) (RNN), denoted in FIG. 2 as RNN 214. The time efficient classification engine 210 may be trained to provide classification of RF signals, for example, using dataset 204 as noted above. The time efficient classification engine 210 may perform classification of RF signals not included in dataset 204 (e.g., perform inferences) after the time efficient classification engine 210 undergoes training (and optionally, validation) cycles.

In an example, the wavelet transform 212 may be a mathematical process that uses the received signal as input and outputs a spectrum or spectrograph (e.g., as in a Fourier transform, etc.) of the frequency components of the received signal. The spectrum or spectrograph may include amplitude vs. frequency information, phase vs. frequency information, both amplitude and phase vs. frequency, such as having a complex-valued representation of the frequency components. Thus, the wavelet transform 212 may provide a time-resolved frequency spectrum with tunable precision between the time domain and the frequency domain.

In an example, the wavelet transform 212 may be a Continuous Wavelet Transform (CWT), which functions by convolving a time-varying signal with a plane wave modulated by a Gaussian envelope. The Gaussian envelope width serves as a configurable parameter that determines how the transform balances resolution between time and frequency domains. When processing finite signal segments, the CWT's Gaussian envelope provides natural tapering at signal boundaries, preventing artificial frequency artifacts that would otherwise appear when analyzing signals of limited duration. This tapering effect allows the CWT to effectively process discrete chunks of data in real-time applications.

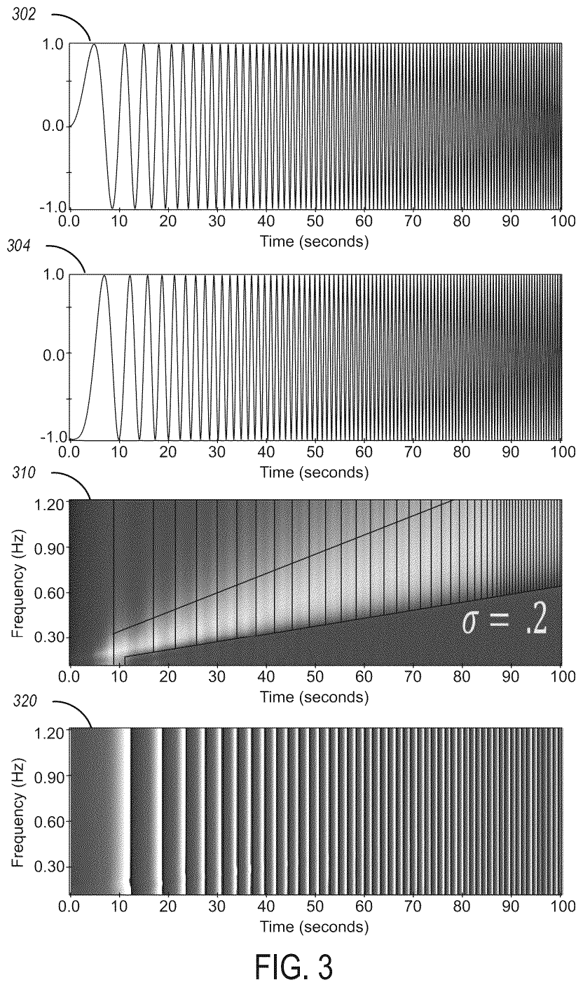

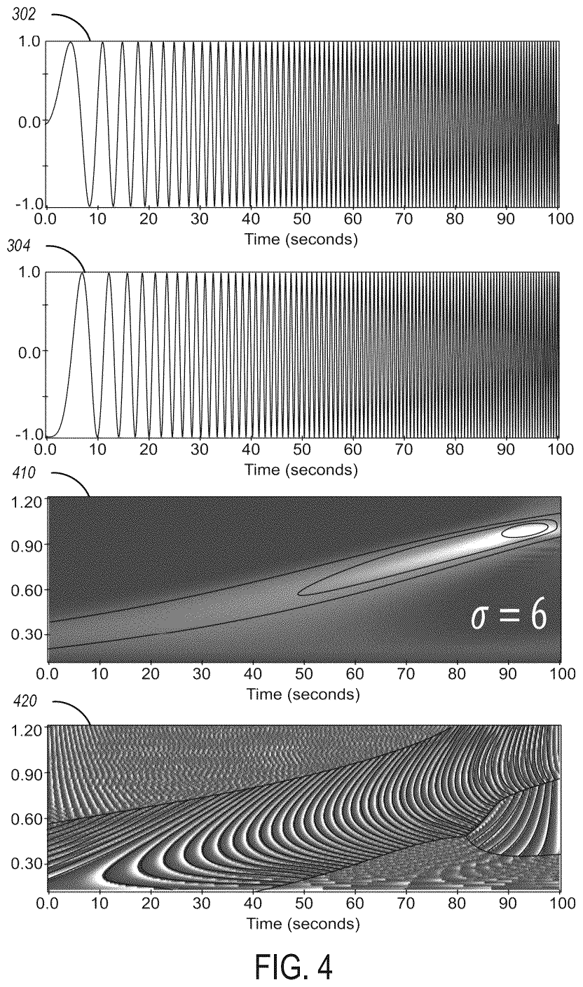

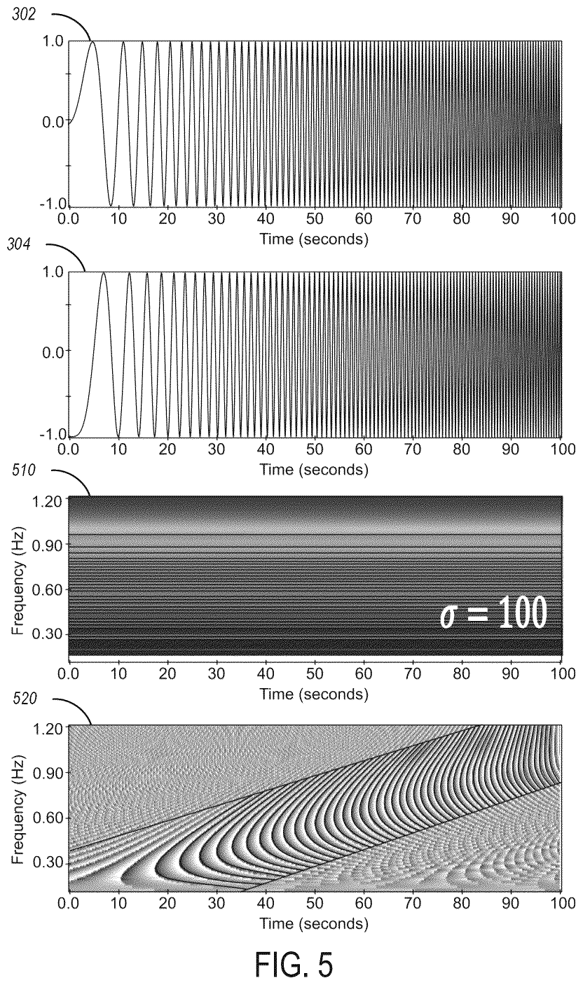

FIG. 3, FIG. 4, and FIG. 5 illustrate graphs of the amplitude (bottom-middle) and phase (bottom) of a continuous wavelet transform of a time-varying signal (top and top-middle) with varying values of a Gaussian envelope width, in accordance with some examples. By adjusting the envelope width (as seen between FIG. 3, FIG. 4, and FIG. 5, and discussed further below), the transform can be configured to prioritize either temporal precision or frequency resolution based on application requirements. Smaller values of the Gaussian envelope width enhance time localization while larger values of the Gaussian envelope width improve frequency discrimination. This adaptability makes the CWT particularly suitable for processing rapidly changing signals across various frequency bands in time-constrained environments. In an example, other time-resolved frequency representations (e.g., a Short Time Frequency Transform, STFT) may be used for the wavelet transform 212.

In an example, wavelet transform 212 may convolve a time-varying signal with a plane wave modulated by a Gaussian envelope, as shown in Equation 1:

$$\text{?} \qquad Equation 1$$

$$\text{?} \text{indicates text missing or illegible when filed}$$

A trait of the wavelet transform 212 is that a Gaussian envelope width, characterized by σ, can be used to provide time localization as a function of the frequency, f, and may be considered a tunable hyperparameter in RF signal analysis of system 200. As a tunable hyperparameter, σ may be determined based on other system parameters, such as n/f, where n is the number of cycles (full periods) at frequency f that fit within the standard deviation of the Gaussian envelope σ. In an example, σ may be fixed. In another example, σ may be allowed to dilate and contract with frequency (e.g., by having a selected value of n). In an example, any suitable frequency dependence rules for σ may be used to generate a spectral input for a neural network (such as RNN 214) to ingest.

To understand the general properties of the wavelet transform 212, FIGS. 3, 4, and 5 present a time-dependent signal S(t) that is transformed with a CWT using varying values for the Gaussian envelope width σ (e.g., 0.2, 6, and 100, respectively). In the example of FIGS. 3, 4, and 5, the signal shown in graph 302 is the real part of S(t) and the signal shown in graph 304 is the imaginary part of S(t):

$$S ( t ) = sin ( π ( \text{.1} + {t}^{2} / 100 ) ) - i cos ( π ( \text{.1} + {t}^{2} / 100 ) )$$

The wavelet transform of S(t) to w(t, f) may be performed with Equation 1 (which may also be known as a Morlet wavelet or a Gabor wavelet), an exponential function having a complex-valued argument modulated by a Gaussian window. To perform the transformation, functions from generally available computational libraries may be used, such as a “fast Continuous Wavelet Transform” (fCWT), a C++ library available on GitHub and able to be integrated into Python, MATLAB, and other C++ environments.

For small values of σ, such as used to generate graph 310 and 320, where σ=0.2, the amplitude and phase spectrograms may exhibit precise time resolution, with unclear localization along the frequency axis. In an example, for the larger values of σ, such as used to generate graph 510 and 520, where σ=100, the spectrograms exhibit precise frequency localization, but lose resolution along the time axis. For intermediate values of σ, such as used to generate graph 410 and 420, where σ=6, balanced precision in the frequency axis and the time axis may be obtained.

Turning to FIG. 3, in an example, the graph 310 is a simplified line graph of a contour plot (spectrogram) of the amplitude, A(t, f), of the signal S(t) transformed using fCWT (e.g., w(t, f)) with a Gaussian envelope width σ of 0.2. The lines shown in graph 310 may represent locations of a larger value (e.g., 1, for a normalized spectrogram) in A(t, f), with values varying to a lower value (e.g., 0) between lines.

In an example, the graph 320 is a simplified line graph of a contour plot (spectrogram) of the phase, ϕ(t, f), of the signal S(t) transformed using fCWT with a Gaussian envelope (e.g., w(t, f)) width σ of 0.2. The lines shown in graph 320 may represent locations of a larger value (e.g., 2π) in ϕ(t, f), with values varying to a lower value (e.g., 0) between lines.

Turning to FIG. 4, in an example, the graph 410 is a simplified line graph of a contour plot (spectrogram) of the amplitude, A(t, f), of the signal S(t) transformed using fCWT (e.g., w(t, f)) with a Gaussian envelope width σ of 6. The lines shown in graph 410 may represent locations of a larger value (e.g., 1, for a normalized spectrogram) in A(t, f), with values varying to a lower value (e.g., 0) between lines.

In an example, the graph 420 is a simplified line graph of a contour plot (spectrogram) of the phase ϕ(t, f) of the signal S(t) transformed using fCWT (e.g., w(t, f)) with a Gaussian envelope width σ of 6. The lines shown in graph 420 may represent locations of a larger value (e.g., 2π) in ϕ(t, f), with values varying to a lower value (e.g., 0) between lines.

Turning to FIG. 5, in an example, the graph 510 is a simplified line graph of a contour plot (spectrogram) of the amplitude, A(t, f), of the signal S(t) transformed using fCWT (e.g., w(t, f) with a Gaussian envelope width σ of 100. The lines shown in graph 510 may represent locations of a larger value (e.g., 1, for a normalized spectrogram) in A(t, f), with values varying to a lower value (e.g., 0) between lines.

In an example, the graph 520 is a simplified line graph of a contour plot (spectrogram) of the phase ϕ(t, f) of the signal S(t) transformed using fCWT (e.g., w(t, f)) with a Gaussian envelope width σ of 100. The lines shown in graph 520 may represent locations of a larger value (e.g., 21) in ϕ(t, f), with values varying to a lower value (e.g., 0) between lines.

Returning to FIG. 2, the RNN 214 may ingest data (e.g., w(t, f) output from the wavelet transform 212) in discrete timesteps. RNNs process time-series data incrementally, analyzing new data as they arrive while maintaining an internal neural network state hₜ that evolves with each timestep according to the input data. This sequential processing structure enables RNNs to begin signal analysis immediately upon receiving the first data point(s), without requiring a complete dataset to be collected before analysis.

The neural network state hₜ may function as a memory aspect that accumulates information about previously observed signal characteristics while processing new inputs. As the RNN receives additional time series data, the RNN continuously updates the task output (e.g., a classification) based on the evolving neural network state, allowing for progressive refinement of an initial assessment (e.g., of the classification) as more information becomes available.

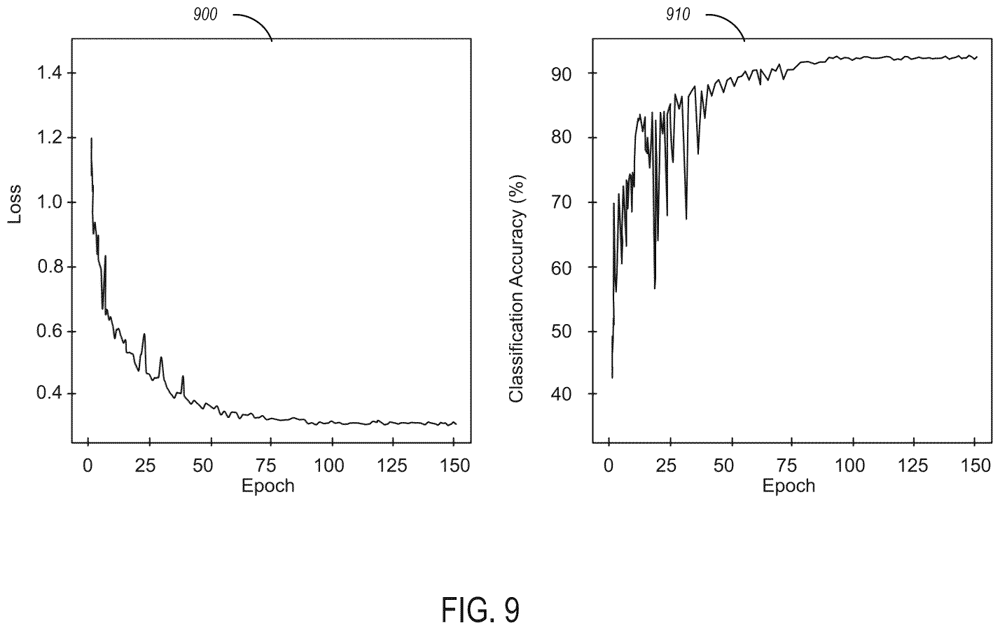

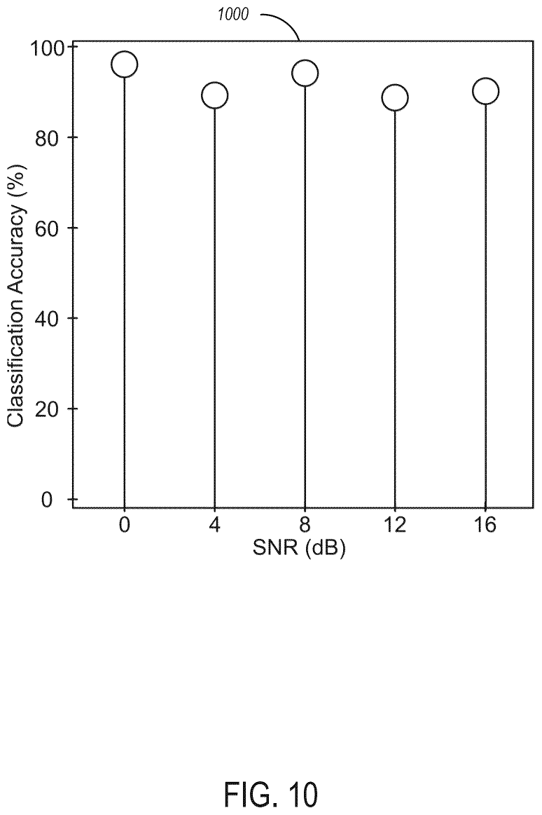

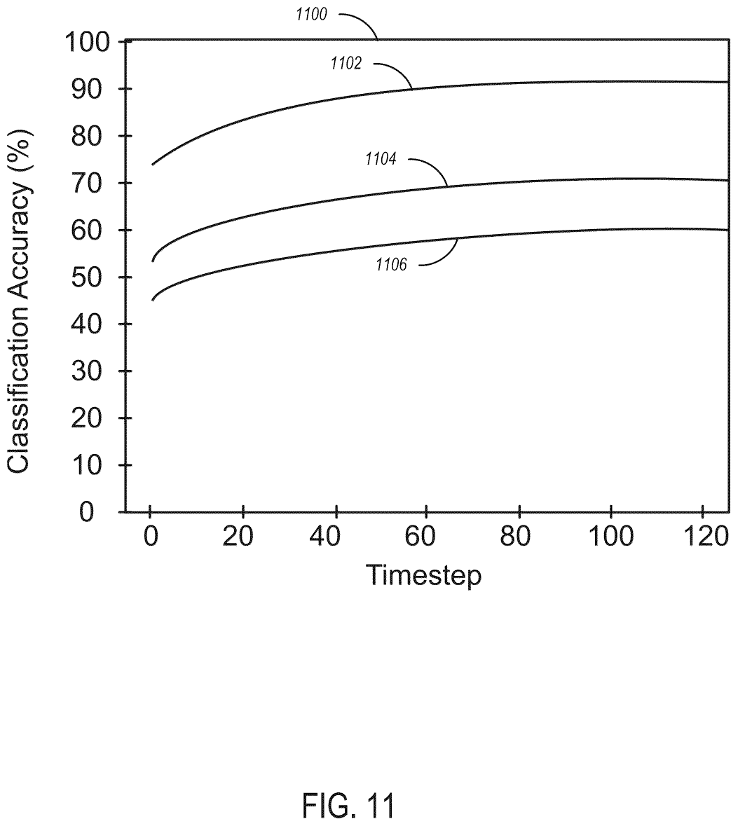

In an example, the neural network state hₜ may be modified during respective inference steps (e.g., time steps of a received time series signal fed into the neural network). As a particular example, the neural network state may have a value hₜ₋₁ at a beginning of processing during time step t, during which the neural network state is then modified to have a value of h_{′t}. The value h_{′t} of the neural network state is then used at the beginning of processing during the next time step t+1. This incremental processing approach can be used for applications requiring immediate decision making based on partial signal information, such as demonstrated in the classification accuracy results as a function of timestep in FIG. 11.

In an example, RNN 214 may be a RNN having one recurrent unit containing 4 linear layers and one neural network state including between 64 to 128 parameters. When using the PyTorch machine learning library, RNN 214 may additionally include two LeakyReLU activations and may execute layer normalization over the amplitude inputs of w (f, t). To enable classification over N-classes, a LogSoftmax operation is applied to the N-element output layer, over which the Negative Log Likelihood loss is calculated. During training. Using the PyTorch machine learning library, the RNN 214 may use an AdamW optimizer and a learning rate scheduler featuring Linear or Exponential rate decay. Training may be performed over 100-300 epochs with batch sizes of 512-1024 signals. In an example, dropout may be added to the first layer with probability 20%-50%. In an example, the combination of wavelet transform 212 used with the RNN 214 may be referred to as the CWT-RNN model of the time efficient classification engine 210.

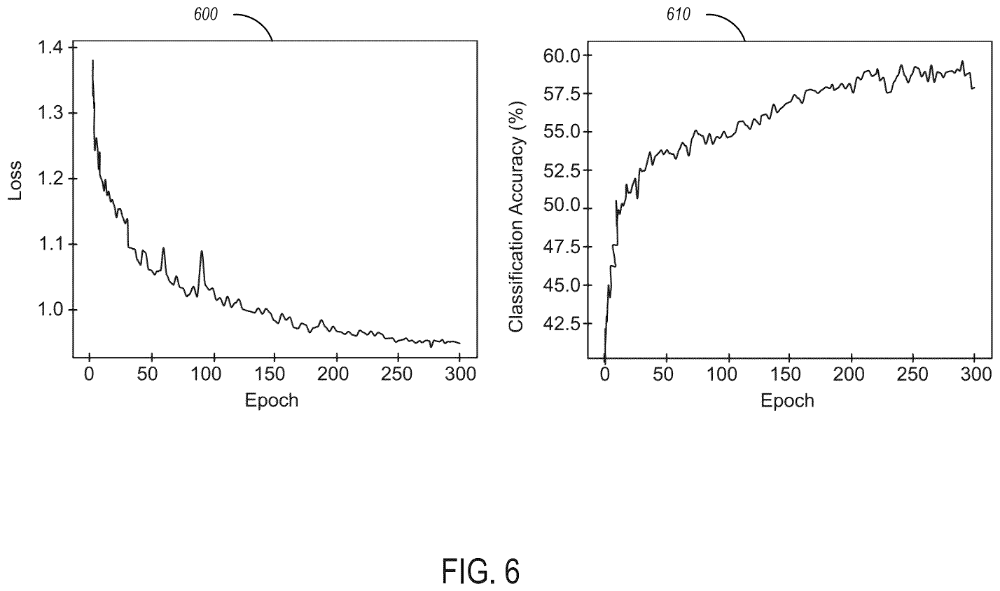

FIG. 6 through FIG. 11 display results of time efficient classification engine 210 processing I/Q signals in the RadioML2016.10A dataset. In an example, the RadioML2016.10A dataset may be used as the dataset 204. The RadioML2016.10A dataset includes 220,000 simulated RF signals across 11 modulation modes, encompassing both digital (8 modes) and analog (3 modes) modulation types. Signals are represented as a 2×128 array, encapsulating In-phase and Quadrature (I/Q) components across 128 time steps, with Signal-to-Noise Ratio (SNR) values ranging from −20 dB to +18 dB.

The dataset may be taken to be in units of seconds, such that I/Q signals constitute 2×128 time series data taken over 128 seconds at a rate of 1 Hz. In an example, the Gaussian envelope can be set to σ=2. In an example, 32 frequency values may be sampled between 1/128 Hz and 0.3 Hz to generate the spectrograms of the amplitude A(t, f) and phase ϕ(t, f). At any given time t′, a 64-element vector V=[A(t′), ϕ(t′)] may be input to the time efficient classification engine 210 with A(t′) and ϕ(t′) each composed of 32 frequency-dependent elements.

The wavelet transform 212 may increase the quantity of parameters used to specify the input to the RNN 214 at any given time (namely, from two values, I(t) and Q(t), to 64 values in the vector V). This input vector V, along with information about neighboring points (e.g., in a nearby time point) may be used to construct localized frequency information. In an example, a representation of the training dataset may be created from which patterns may be deduced by the RNN 214.

FIG. 6 illustrates graph 600 and graph 610 of results for a modulation classification task from a neural network processing a time-resolved frequency representation of radio frequency signals, in accordance with some examples. For the graphs of FIG. 6, a high-SNR subset (0-18 dB) containing 84,000 training examples and 25,000 validation examples may be used from the RadioML2016.10A dataset.

In an example, graph 600 shows the loss as a function of the training epoch for the time efficient classification engine 210 trained on the RadioML2016.10A dataset. In an example, graph 610 shows the classification accuracy as a function of the training epoch for a classification task to classify a modulation of a signal from one of the 11 modulation modes (8 digital, 3 analog). In an example, the classification accuracy may be defined as the percentage of top-1 true positives in all examples considered. As seen in graph 610, across SNR levels, the classification accuracy is approximately 60%. In an example, the per-modulation performance may exhibit a bimodal distribution with the time efficient classification engine 210 able to classify 5 modulations at a classification accuracy of 87% or above.

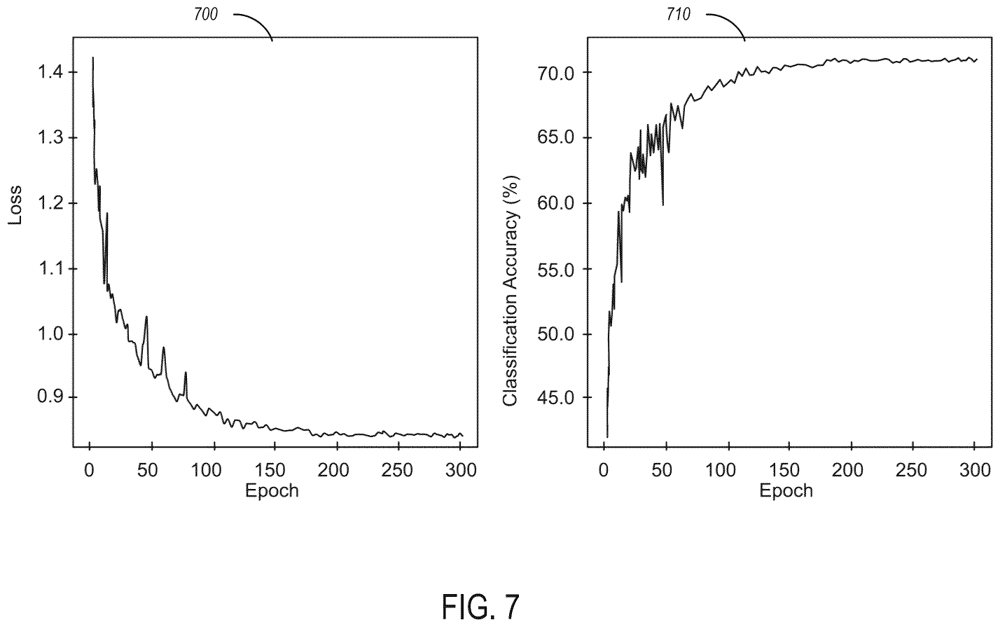

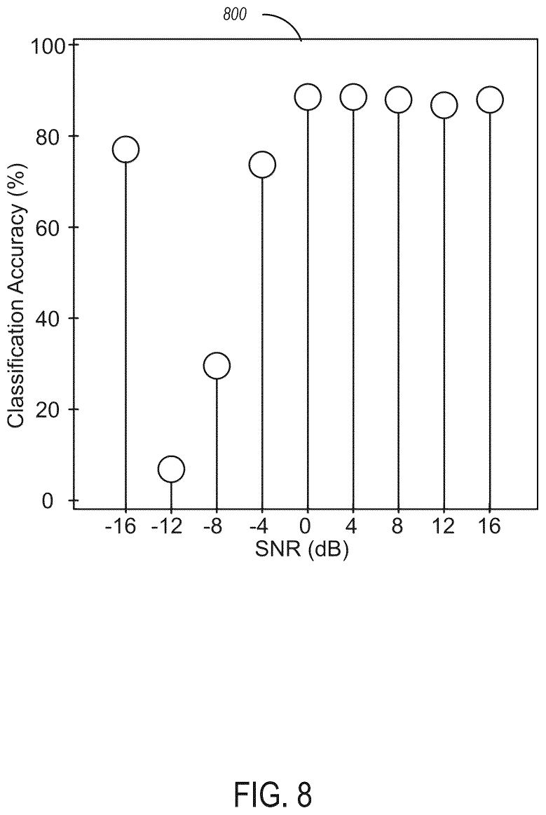

FIG. 7 and FIG. 8 include results for the time efficient classification engine 210 trained on the RadioML2016.10A dataset for a classification task to classify a SNR of a signal from one of 9 SNR categories spanning −16 dB to 16 dB. For the graphs of FIG. 7 and FIG. 8, 80,000 training examples and 18,000 validation examples from the RadioML2016.10A dataset may be used. In an example, graph 700 shows the loss as a function of the training epoch, graph 710 shows the classification accuracy as a function of the training epoch, and graph 800 shows the final classification accuracy for a given SNR of the 9 SNR classes. Final classification accuracy over the validation examples may approach 70% overall.

FIG. 9 and FIG. 10 include results for the time efficient classification engine 210 trained on the RadioML2016.10A dataset for a classification task to classify a SNR of a signal from one of 5 SNR classes spanning a high-SNR split of 0 dB to 16 dB. For the graphs of FIG. 9 and FIG. 10, 44,000 training examples and 10,000 validation examples from the RadioML201610A dataset may be used. In an example, graph 900 shows the loss as a function of the training epoch, graph 910 shows the classification accuracy as a function of the training epoch, and graph 1000 shows the final classification accuracy for a given SNR of the 5 SNR categories. Final classification accuracy over the validation examples may approach 90% overall.

In an example, identifying decision boundaries in the low-SNR regime may represent an increased complexity for the time efficient classification engine 210. In an example, the classification performance in the low-SNR regime may be addressed by increasing the model size or by considering alternative RNN models with more sophisticated contextuality mechanisms, such as the Long Short Term Memory (LSTM) Model.

FIG. 11 illustrates a graph 1100 of results for classification tasks from a neural network processing a time-resolved frequency representation of radio frequency signals, in accordance with some examples. In graph 1100, time-series inputs from the RadioML201610A dataset may be fed into the time efficient classification engine 210 in a real-time fashion, to evaluate real-time low-latency (e.g., online) RF decision making.

Results of different classification tasks may be shown in different curves. For example, curve 1102 shows real-time classification accuracy for time series data classified by the time efficient classification engine 210 trained on the 5 categories of SNR classification training examples as described above for FIG. 9 and FIG. 10. In an example, curve 1104 shows real-time classification accuracy for time series data classified by the time efficient classification engine 210 trained on the 9 categories of SNR classification training examples as described above for FIG. 7 and FIG. 8. In an example, curve 1106 shows real-time classification accuracy for time series data classified by the time efficient classification engine 210 trained on the 11 category modulation training examples as described above for FIG. 6.

As time series records are fed into the trained time efficient classification engine 210 in an online fashion, the output for respective timesteps may be evaluated as a preliminary classification, the average accuracy of which is shown in FIG. 11. The time efficient classification engine 210 may exhibit high accuracy from the first time series input. For example, the curve 1102 begins with over 70% accuracy at the first timestep, the curve 1104 begins with over 50% accuracy at the first timestep.

The time efficient classification engine 210 may achieve a maximum classification accuracy at a timestep which is a subset of the total length of the time series record. The results shown in FIG. 11 indicate that the time efficient classification engine 210 may provide accurate RF signal analysis. In an example, the time efficient classification engine 210 may be capable of rapid online decision-making in real time with minimal signal input. Furthermore, the time efficient classification engine 210 may facilitates a flexible approach where additional time-series inputs may be continuously provided to the time efficient classification engine 210 to improve a confidence of the classification output.

As indicated above in FIG. 2, the classification output may be a set of time-ordered pairs with a label referring to a value within the classification task. Prior to the time efficient classification engine 210 outputting the classification label for a given portion of an RF signal, the RNN 214 may output an array A of N floating point values such that sum(A)=1, where N is the number of possible labels in the classification task. Taking as a particular example the modulation classification task with N=11 modulation types (e.g., as discussed above in connection with FIG. 6), a given portion of an input signal (e.g., S(t)=S(t)ᵢ) to the RNN 214 for the modulation classification task may have a corresponding array output from RNN 214 of possible classifications as shown in Table 1:

TABLE 1

| Index for | | |
|---|---|---|
| classification | Classification | RNN 214 |
| label | Label | output |
| 1 | BPSK | 0.0163 |
| 2 | QPSK | 0.5810 |
| 3 | 8PSK | 0.1456 |
| 4 | 16QAM | 0.0567 |
| 5 | 64QAM | 0.0585 |
| 6 | BFSK | 0.0581 |
| 7 | CPFSK | 0.0622 |
| 8 | PAM4 | 0.0105 |
| 9 | WB-FM | 0.0051 |
| 10 | AM-SSB | 0.0034 |
| 11 | AM-DSB | 0.0027 |

In this example, the maximum value in Table 1 for the RNN 214 output is 0.5810, corresponding to index 2. Thus, the time efficient classification engine 210 may select the “QPSK” classification for the given portion Sᵢ. The difference between the RNN 214 output for this index (e.g., 0.5810) and 1 may be treated as an uncertainty value (e.g., 1−0.5810=0.419). Continuing this example, the next portion of the input signal (e.g., S(t)=S(t)ᵢ₊₁) may have an RNN 214 output of 0.6255 for the “QPSK” classification. Thus, as the maximum value of the array A increase towards 1.0, the confidence of the model may be increasing (e.g., from 0.5810 to 0.6255, etc.).

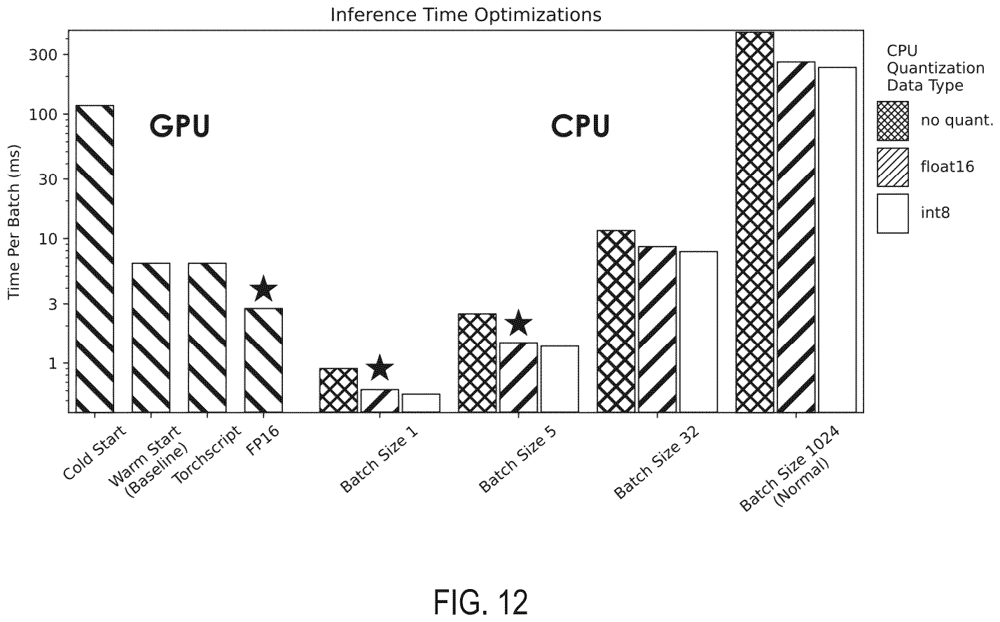

FIG. 12 illustrates a graph of results for various processor configurations to reduce inference latency (e.g., inference time) in accordance with some examples. It should be noted that the terms “inference latency” and “inference time” may be interchangeable throughout. In an example, various processor configurations may be used to reduce latency for inferences made to a trained deep learning model. In an example, the time efficient classification engine 210 may include a 4-layer neural network with 2 convolutional layers and 2 dense fully connected layers. The layers may utilize a LeakyReLu activation function, and a Softmax activation on the one-hot encoding output layer.

In an example, inference time benchmarks may be assessed on any suitable computer hardware, such as an AWS EC2 g5.xlarge instance, which has an NVIDIA A10G GPU with 24 GiB of GPU memory, 4 AMD EPYC 7R32 vCPUs, and 16 GiB of memory. In an example, inference time benchmarks may be assessed with a gradient evaluation disabled and without dropout layers, so that artifacts of training are not included in runtime measurements.

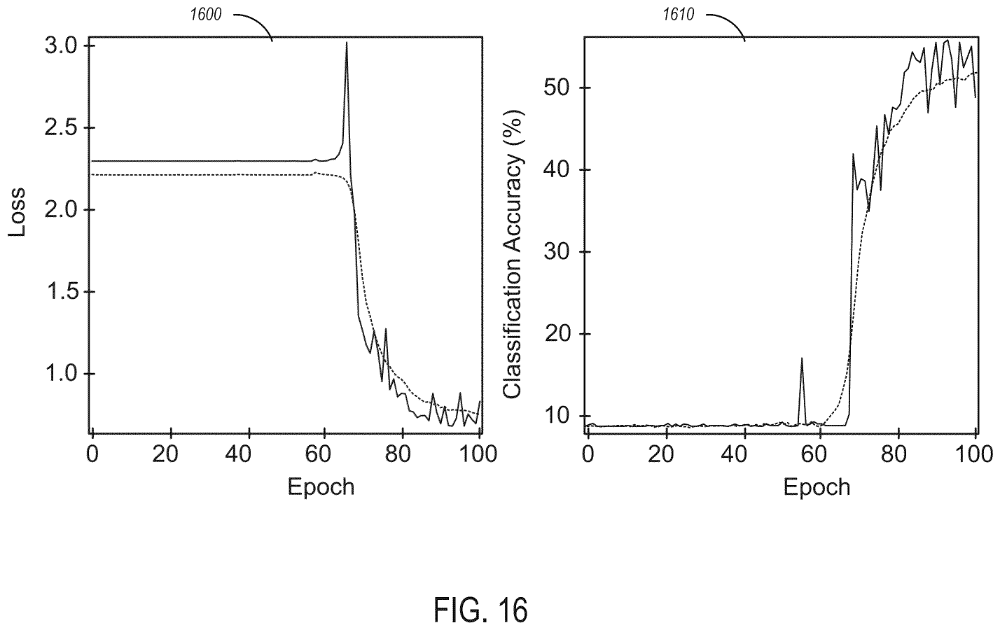

The various computer configurations shown in FIG. 16 include inferences performed when the trained deep learning model is loaded and initiated on a graphics processing unit (GPU) (e.g., cold start, warm start (baseline), Torchscript, FP16), and inferences performed when the trained deep learning model is loaded and initiated on a central processing unit (CPU). In an example, inferences performed on the CPU are presented for various batch sizes (e.g., 1, 5, 32, 1024) used during the training of the deep learning model, where the batch size refers to a number of training records processed before the model parameters are updated.

### GPU Inference

In an example, a cold start may include scenarios where a model is loaded and initiated on a GPU from an inactive state, with no preloaded data or prior computation caching. This situation may occur in real-world applications when GPU hardware restarts or when a model is deployed for the first time without any preliminary execution. The cold start inference benchmark may be performed by rebooting the GPU through any suitable command line prompt (e.g., nvidia-smi--gpu-reset). As shown in FIG. 16, a cold-start inference time per batch (1024 inputs) of 115 ms may be determined.

In an example, a warm start may include scenarios where a model is loaded and initiated by running the model any suitable number of times (e.g., 10 times) prior to inference of the model. In an example, a warm start may improve inference latency (over a cold start) by keeping the model and its associated data loaded in memory. The prior runs of the model “warm up” the system, ensuring that data paths are established and computational resources are allocated, which contributes to reducing inference latency compared to a cold start.

In an example, a warm start inference time of 6.500 ms per batch may be determined, which is more than 18 times faster than the cold start inference time (115 ms as noted above).

In an example, a compiling technique (“Torchscript”) for high performance environments may be included in the inference benchmarks shown in FIG. 16. In an example, TorchScript (via torch.jit.trace) may be used to compile PyTorch models into a form that can be run in a high-performance environment independent of Python. This process optimizes the model for faster execution. In an example, inference latency performance may be improved by enabling integration with lower-level system components and hardware acceleration. In an example, the “Torchscript” inference time of 6.511 ms per batch may be determined.

In an example, a computational technique (“FP16”) may be benchmarked. In an example, a half-precision floating point format (FP16), which reduces the number of bits used to represent numbers in computations from 32 bits (as in single precision) to 16 bits, may be used. The model parameters (e.g., as determined by the model during use with a training dataset) may be stored as 32 bit single precision and reduced to 16 bits by using any specified function (e.g., using.half( ) in a Torch, PyTorch, or Python environment). Using a reduced number representation may accelerate model inference latency by allowing more operations to be performed in parallel and reducing the data transfer load between the CPU and GPU.

In an example, the FP16 mixed precision GPU inference time of 2.831 ms per batch may be determined, which is 2.3× faster than the warm start (6.500 ms as noted above). In an example, changing precision (e.g., from 32 bit to 16 bit) may result in degradation of output classification accuracy. In the example for determining the inference time of 2.831 ms per batch, a classification accuracy of the validation set changed from 53.484% on the Baseline un-quantized implementation to 53.480%. In this example, the FP16 implementation made two additional classification errors on the validation set than the warm start implementation.

### CPU Inference

In an example, inference time benchmarks for inferences on a CPU may be determined. GPU hardware may be advantageous (relative to CPU hardware) for training a model, while using CPU hardware to serve trained models for inference may provide faster inference times than using GPU hardware. One aspect that influences time benchmarks is the batch size. Batching (e.g., of data) may happen during training (e.g., batching of the training data) and during inference (e.g., batching of received RF signals). A training dataset may be readily available in a database so large batching of a training dataset may be used to avoid overhead from swapping data in and out of GPU hardware. In an online, real-time scenario (e.g., during inference), batching the received data may be constrained by a rate at which data is received, thus smaller batching may be used to process the real-time data and receive classifications faster.

For CPU inferences in the following time benchmarks, batch sizes on the inference data were varied.

For many RF signal processing applications, it may be unlikely that RF signal evaluation will utilize simultaneous inference on batch sizes as large as 1024, which is the batch size used for benchmarking inference times on the GPU hardware discussed above. For the results presented in FIG. 16, different batch sizes were used when using verification (or inference) data. In an example, additional parameters may be adjusted, such how the model weights defining the neural network are quantized for CPU inference, with no quantization (e.g., a default 32 bit floating point precision), with int8 (e.g., 8 bit integer precision) and with float16 (e.g., 16 bit floating point precision) data types. Model quantization may be performed by using PyTorch's quantize_dynamic function, which is not available for CUDA/GPU. While the model quantization process is similar to the FP16 half precision implementation used for GPU (as discussed above), model quantization is dynamic in nature, applying scale factors based on computations observed at runtime.

### No Quantization

In an example, a batch size of 1024 may be used on a CPU with no model quantization, and an inference time of 444 ms per batch may be determined. In an example, additional batch sizes of 1, 5, and 32 may be determined. As shown in FIG. 16, for a batch size of 1, an inference time of 0.94 ms may be determined. For a batch size of 5, an inference time of 2.52 ms may be determined. For a batch size of 32, an inference time of 11.7 ms may be determined.

In an example, the classification accuracy with no model quantization may be approximately 53.4% (for a validation set).

### Float16 Quantization

Float16 quantization may refer to a conversion of the model weights from a default (e.g., 32 bit floating point precision) to 16 bit floating point representation. In an example, a batch size of 1024 may be used on a CPU with float16 quantization applied to the model, and an inference time of approximately 257 ms per batch may be determined. In an example, additional batch sizes of 1, 5, and 32 may be determined with float16 quantization applied to the model. As shown in FIG. 16, for a batch size of 1, an inference time of approximately 0.65 ms may be determined. For a batch size of 5, an inference time of approximately 1.5 ms may be determined. For a batch size of 32, an inference time of approximately 8.8 ms may be determined.

In an example, the classification accuracy of the float 16 quantized implementation may be 53.4% (for a validation set).

### Int8 Quantization

Int8 quantization may refer to a conversion of the model weights from a default (e.g., 32 bit floating point precision) to 8 bit integer representation. In an example, a batch size of 1024 may be used on a CPU with int8 quantization applied to the model, and an inference time of approximately 300 ms per batch may be determined. In an example, additional batch sizes of 1, 5, and 32 may be determined with int8 quantization applied to the model. As shown in FIG. 16, for a batch size of 1, an inference time of approximately 0.54 ms may be determined. For a batch size of 5, an inference time of approximately 1.5 ms may be determined. For a batch size of 32, an inference time of approximately 7.5 ms may be determined.

In an example, the classification accuracy of the int8 quantized implementation may be approximately 42.1% (for a validation set).

In an example, three implementations (seen in FIG. 16 with a star above the relevant bar in the bar chart) may be considered suitable for real world deployment: FP16 half-precision on GPU batch size 1024 (2.83 ms), float16 dynamic quantization on CPU with batch size 1(0.65 ms), and float16 dynamic quantization on CPU with batch size 5 (1.50 ms).

While all three starred implementations involve quantization, output classification accuracy may be nearly unchanged for these implementations. These three implementations are 2.3-10× faster than the Baseline warm start GPU setting and 41-177× faster than the cold start GPU setting.

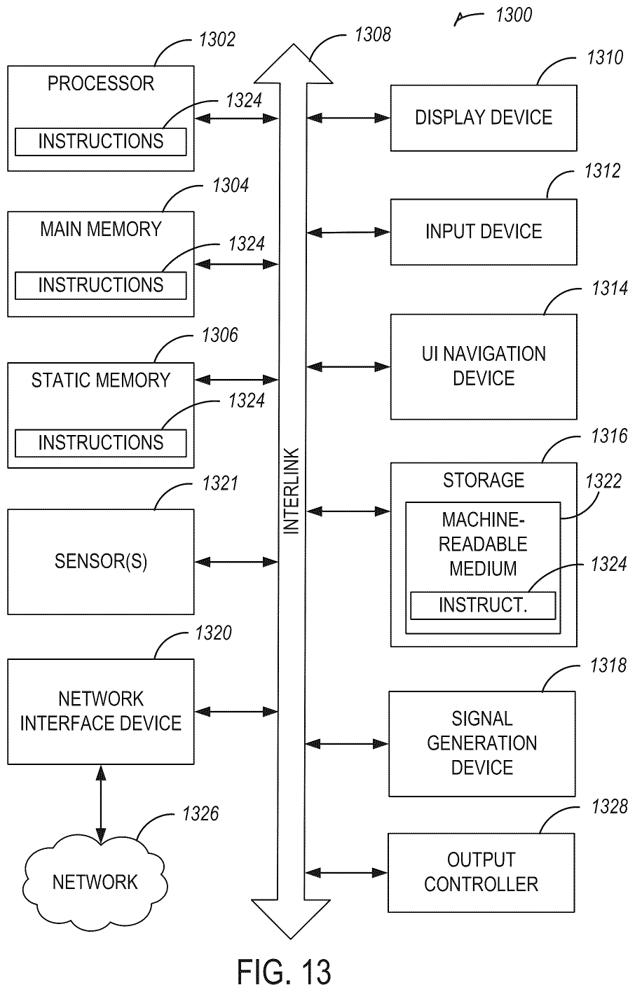

FIG. 13 illustrates generally an example of a block diagram of a computing machine 1300 upon which any one or more of the techniques (e.g., methodologies) discussed herein may perform in accordance with some examples. In alternative embodiments, the machine 1300 may operate as a standalone device or may be connected (e.g., networked) to other machines. In a networked deployment, the machine 1300 may operate in the capacity of a server machine, a client machine, or both in server-client network environments. In an example, the machine 1300 may act as a peer machine in peer-to-peer (P2P) (or other distributed) network environment. The machine 1300 may be a server computer, a personal computer (PC), a tablet PC, a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Such components are tangible entities (e.g., hardware) capable of performing specified operations when operating. In an example, the hardware may be configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one component. For example, under operation, the execution units may be configured by a first set of instructions to implement a first component at one point in time and reconfigured by a second set of instructions to implement a second component.

Computing machine (e.g., computer system) 800 may include a hardware processor 1302 (e.g., a central processing unit (CPU), a graphics processing unit (GPU), a hardware processor core, or any combination thereof), a main memory 1304 and a static memory 1306, some or all of which may communicate with each other via an interlink (e.g., bus) 808. The computing machine 1300 may further include a display unit 1310, an alphanumeric input device 1312 (e.g., a keyboard), and a user interface (UI) navigation device 1314 (e.g., a mouse). In an example, the display unit 1310, alphanumeric input device 1312 and UI navigation device 1314 may be a touch screen display. The computing machine 1300 may additionally include a storage device (e.g., drive unit) 1716, a signal generation device 1318 (e.g., a speaker), a network interface device 1320, and one or more sensors 1321, such as a radio-frequency receiver, a quantum radio-frequency receiver, global positioning system (GPS) sensor, compass, accelerometer, or other sensor. The computing machine 1300 may include an output controller 1328, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 1316 may include a machine readable medium 1322 that is non-transitory on which is stored one or more sets of data structures or instructions 1324 (e.g., software) embodying or utilized by any one or more of the techniques or functions described herein. The instructions 1324 may also reside, completely or at least partially, within the main memory 1304, within static memory 1306, or within the hardware processor 1302 during execution thereof by the computing machine 1300. In an example, one or any combination of the hardware processor 1302, the main memory 1304, the static memory 1306, or the storage device 1316 may constitute machine readable media.

While the machine readable medium 1322 is illustrated as a single medium, the term “machine readable medium” may include a single medium or multiple media (e.g., a centralized or distributed database, or associated caches and servers) configured to store the one or more instructions 1324. The term “machine readable medium” may include any medium that is capable of storing, encoding, or carrying instructions for execution by the computing machine 1300 and that cause the computing machine 1300 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1324 may further be transmitted or received over a communications network 1326 using a transmission medium via the network interface device 1320 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, LoRa®/LoRaWAN® LPWAN standards, etc.), IEEE 802.15.4 family of standards, peer-to-peer (P2P) networks, 3rd Generation Partnership Project (3GPP) standards for 4G and 5G wireless communication including: 3GPP Long-Term evolution (LTE) family of standards, 3GPP LTE Advanced family of standards, 3GPP LTE Advanced Pro family of standards, 3GPP New Radio (NR) family of standards, among others. In an example, the network interface device 1320 may include one or more physical jacks (e.g., Ethernet, coaxial, or phone jacks) or one or more antennas to connect to the communications network 1326. In an example, the network interface device 1320 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 1300, and includes digital or analog communications signals or other intangible medium to facilitate communication of such software.

Quantum radio frequency (QRF) sensors are sensing hardware that are based on Rydberg atoms. QRF sensors may have a broad frequency range, high resolution, high sensitivity, and minimal disturbance to sensed signals. QRF technology can provide, for example ultra-wideband coverage spanning spectrum detection from HF (3-30 MHz) to SHF (3-30 GHZ). An individual QRF receiver may be broadband enough (e.g., Hz to THz) to replace multiple RF receivers, leading to significant reductions in size, weight, power, and cost. QRF receivers may provide RF time series data to process across a wide band of frequencies. Prior RF receivers may provide RF time series data to process across discrete frequency bands such that separate processors may be used for respective frequency bands. Thus, QRF time series data may be processed using machine learning techniques for RF processing.

FIG. 14 illustrates an atomic level diagram of Rydberg transitions used in a quantum radio frequency (QRF) sensor. In an example, the atomic level diagram shown in FIG. 14 may be used in a physics simulation (e.g., RydIQule, Rydberg Interactive Quantum module, available as a Python module and on GitHub) that simulates the interaction of Rydberg atoms with one or more RF input tones. There are five RF tones that may be detected using the atomic level diagram of FIG. 14. Rydberg atoms may produce time series data in response to an RF input tone through absorption or transmission of different laser wavelengths through an atomic vapor that is excited to a Rydberg state (e.g., the 56 D5/2 state) through additional laser inputs (e.g., pump laser, dressing laser, etc.). Thus, a transition from the 56D5/2 state to the 52F7/2 state may occur when an RF tone at or near 116 GHz is incident on the QRF sensor. A transition from the 56D5/2 state to the 54F7/2 state may occur when an RF tone at or near 65.1 GHz is incident on the QRF sensor. A transition from the 56D5/2 state to the 57P3/2 state may occur when an RF tone at or near 27.4 GHz or 12.1 GHz is incident on the QRF sensor (e.g., two level states exist within the 57P3/2 state through multiple additional quantum states such as hyperfine states in the 57P3/2 state). A transition from the 56D5/2 state to the 59P2/2 state may occur when an RF tone at or near 1.72 GHz is incident on the QRF sensor.

In an example, any other suitable atomic level diagram of Rydberg transitions may be used in place of that shown in FIG. 14.

In an example, a physics simulation may be used to generate any quantity of samples (e.g., 1000 samples) of time series data for respective ones in 11 linear combinations of the five input tones noted above (e.g., 1.72, 12.1, 27.4, 65.1, and 116 GHZ). The samples of time series data may have any suitable signal to noise ratio(s) (e.g., 20 categories of SNR from −20 dB to +18 dB). In an example, 220,000 labeled (e.g., with frequency components and SNR) samples of time series data may be generated by the physics simulation. The samples of time series data may be used as dataset 204 as discussed above in connection with FIG. 2.

FIG. 15 illustrates examples of quantum radio frequency time series data from a simulation of the atomic level diagram of FIG. 14 in accordance with some examples. In the example of graph 1500, in-phase (I) time series data is presented in the dashed line for a single input tone (e.g., at 12.1 GHZ). The quadrature (Q) time series data is presented in the solid line of graph 1500. In the example of graph 1510, in-phase (I) time series data is presented in the dashed line for a combination of two input tones (e.g., 27.4 GHz and 65.1 GHZ). The quadrature (Q) time series data for the combination of two input tones is presented in the solid line of graph 1510. In the example of graph 1520, in-phase time series data is presented in the dashed line for a combination of four input tones (e.g., 1.72 GHZ, 12.1 GHZ, 27.4 GHz, and 65.1 GHZ). The quadrature (Q) time series data for the combination of four input tones is presented in the solid line graph of 1520.

It should be noted that the time series data in FIG. 15 are not easily visually distinguished in the time domain. In this example, a time efficient classification engine 210, e.g., based on a CNN or CWT-RNN, may provide classification results in real-time.

The simulated time series data from a QRF sensor (described above, and examples shown in FIG. 15) may be input (e.g., as dataset 204 in FIG. 2) to a machine learning model such as time efficient classification engine 210. In an example, the time efficient classification engine 210 may have a CNN architecture and may have a classification accuracy of approximately 56.4% as shown in the results of FIG. 16. The loss and classification accuracy (e.g., for SNR classification, for frequency component classification) are shown in the graphs of FIG. 16 for the time efficient classification engine 210 performing classifications of the simulated time series data from a QRF sensor.

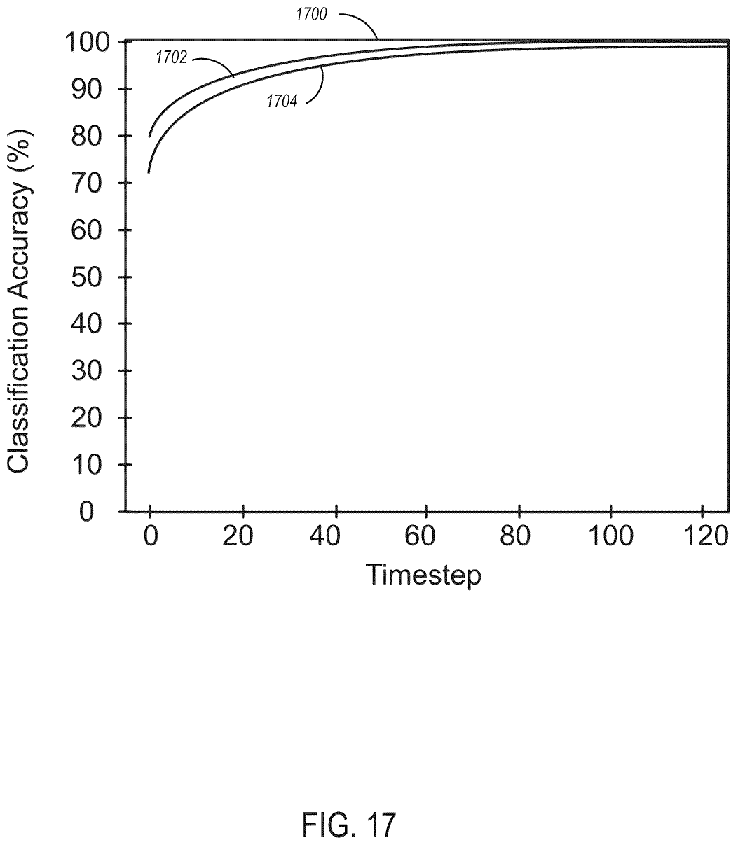

FIG. 17 illustrates a graph 1700 of results for signal-to-noise classification tasks from a neural network processing a time-resolved frequency representation of quantum radio frequency time series data, in accordance with some examples. In an example, the time efficient classification engine 210 may have a CWT-RNN architecture (e.g., using wavelet transform 212 and RNN 214) as described above in FIG. 2 and FIG. 5. In graph 1700, time-series inputs from the simulated QRF dataset described above may be fed into the time efficient classification engine 210 in a real-time fashion, to evaluate real-time low-latency RF decision making.

Results of different classification tasks may be shown in different curves. For example, curve 1702 shows real-time classification accuracy for time series data classified by the time efficient classification engine 210 trained on examples from the QRF dataset described above having 5 classes of SNR. In an example, curve 1704 shows real-time classification accuracy for time series data classified by the time efficient classification engine 210 trained on the QRF dataset described above having 9 classes of SNR. In both curve 1702 and 1704, the time efficient classification engine 210 may provide a top-1 classification accuracy of 70% at the first timestep of the time series data. As additional time series data is fed into the model, the classification accuracy increases relative to the classification accuracy at earlier timesteps (e.g., as the timestep increases). A classification accuracy above 95% may be determined for the classification tasks reported by graph 1700.

In addition to the I/Q time series data presented in FIG. 15, QRF sensors themselves are capable of outputting an indication of a frequency of an incoming RF tone. In particular, this is due to the Rydberg transitions and construction of a suitable detection scheme. For example, a probe laser can be detuned across the 5P3/2 to 56D5/2 transition (shown in FIG. 14), and variations in transmission through the atomic vapor of the probe laser beam may occur at frequencies corresponding to the Rydberg transitions. In another example, a local oscillator may be included in the QRF, which, in addition to the probe laser as described, may provide multiple spectral features that combine to indicate a frequency of an incident RF field (e.g., by measuring a distance between two transmission peaks, etc.). In an example, such a QRF sensor may generate a time series output comprising a time-frequency representation, bypassing the use of input I/Q time series data to a signal transformation (e.g., a wavelet transform).

The following, non-limiting examples, detail aspects of the present subject matter to solve the challenges and provide the benefits discussed herein, among others.

Example 1 is a method for processing a radio frequency (RF) signal, the method comprising: receiving at least one portion of an RF signal, the RF signal comprising a number of portions; transforming the at least one portion of the RF signal into a time-resolved frequency representation that includes, both time and frequency information; processing the time-resolved frequency representation using a neural network, wherein the neural network includes a neural network state, wherein the neural network processes the time-resolved frequency representation in time increments such that the neural network state is modified at respective time increments to provide a modified neural network state that is used by the neural network in a next respective time increment; and generating a classification output based on the neural network modifying the neural network state over one or more time increments of processing of the time-resolved frequency representation, corresponding to at least some of the number of portions of the RF signal.

In Example 2, the subject matter of Example 1 includes, wherein the classification output contributes to an analysis task of the RF signal.

In Example 3, the subject matter of Example 2 includes, wherein the classification output comprises at least one of: modulation classification, signal-to-noise ratio (SNR) classification, or jamming detection.

In Example 4, the subject matter of Examples 2-3 includes, detecting a jamming component in the RF signal based on the classification output; and at least one of removing or attenuating the jamming component from the RF signal.

In Example 5, the subject matter of Examples 1-4 includes, wherein transforming the at least one portion of the RF signal comprises performing a continuous wavelet transform (CWT) on the at least one portion of the RF signal.

In Example 6, the subject matter of Example 5 includes, wherein the CWT includes a selectable Gaussian envelope width.

In Example 7, the subject matter of Example 6 includes, wherein a value for the selectable Gaussian envelope width varies during processing of different portions of the RF signal.

In Example 8, the subject matter of Examples 6-7 includes, selecting a value for the selectable Gaussian envelope width to favor improving time resolution of the time-resolved frequency representation over improving frequency resolution of the time-resolved frequency representation.

In Example 9, the subject matter of Examples 6-8 includes, selecting a value for the selectable Gaussian envelope width to favor improving frequency resolution of the time-resolved frequency representation over improving time resolution of the time-resolved frequency representation.

In Example 10, the subject matter of Examples 1-9 includes, wherein the neural network comprises a recurrent neural network (RNN).

In Example 11, the subject matter of Examples 1-10 includes, wherein the classification output includes a confidence parameter that increases in confidence as the neural network performs additional time increments of processing of the time-resolved frequency representation, corresponding to processing additional portions of the RF signal.

In Example 12, the subject matter of Examples 1-11 includes,) a maximum number of time increments are processed.

In Example 13, the subject matter of Examples 1-12 includes, configured to provide a sub-millisecond inference latency.

In Example 14, the subject matter of Example 13 includes, configured to provide a sub-millisecond inference latency including using at least one of: model quantization, batch size optimization, or processor-specific optimization.

In Example 15, the subject matter of Examples 1-14 includes, wherein the RF signal is received from a quantum RF sensor based on a Rydberg atom.

In Example 16, the subject matter of Example 15 includes, deriving the time-resolved frequency representation from transitions between Rydberg energy states of the Rydberg atom.

In Example 17, the subject matter of Examples 15-16 includes, wherein the RF signal comprises multiple RF tones spanning a frequency range of at least 100 GHz.

Example 18 is a system for processing a radio frequency (RF) signal, the system comprising one or more processors; a memory storing instructions that, when executed by the one or more processors, cause the system to perform operations comprising: receiving at least one portion of an RF signal, the RF signal comprising a number of portions; performing a continuous wavelet transform (CWT) on the at least one portion of the RF signal; processing a CWT representation of the at least one portion of the RF signal using a recurrent neural network (RNN), wherein the RNN includes, a neural network state, wherein the RNN processes the CWT representation in time increments such that the neural network state is modified at respective time increments to provide a modified neural network state that is used by the RNN in a next respective time increment; and generating a classification output based on the RNN modifying the neural network state over one or more time increments of processing of the CWT representation, corresponding to at least some of the number of portions of the RF signal.

In Example 19, the subject matter of Example 18 includes, wherein the CWT includes a selectable Gaussian envelope width, wherein a value for the selectable Gaussian envelope width may be dynamically selected for processing different portions of the RF signal.

Example 20 is a non-transitory computer-readable storage medium, the computer-readable storage medium including instructions that when executed by a processor of a system, cause the system to perform operations comprising: receiving at least one portion of an RF signal, the RF signal comprising a number of portions; performing a continuous wavelet transform (CWT) on the at least one portion of the RF signal, wherein the CWT includes, a selectable Gaussian envelope width, wherein a value for the selectable Gaussian envelope width may be dynamically selected for processing different portions of the RF signal; processing a CWT representation of the at least one portion of the RF signal using a recurrent neural network (RNN), wherein the RNN includes a neural network state, wherein the RNN processes the CWT representation in time increments such that the neural network state is modified at respective time increments to provide a modified neural network state that is used by the RNN in a next respective time increment; and generating a classification output based on the RNN modifying the neural network state over one or more time increments of processing the CWT representation, corresponding to at least some of the number of portions of the RF signal.

Example 21 is an apparatus comprising means to implement of any of Examples 1-20.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. The present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described subject matter (or one or more aspects thereof) may be used in combination with each other. Other embodiments may be used, such as by one of ordinary skill in the art upon reviewing the above description. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

What is claimed is:

1. A method for processing a radio frequency (RF) signal, the method comprising:
receiving at least one portion of an RF signal, the RF signal comprising a number of portions;
transforming the at least one portion of the RF signal into a time-resolved frequency representation that includes both time and frequency information;
processing the time-resolved frequency representation using a neural network, wherein the neural network includes a neural network state, wherein the neural network processes the time-resolved frequency representation in time increments such that the neural network state is modified at respective time increments to provide a modified neural network state that is used by the neural network in a next respective time increment; and
generating a classification output based on the neural network modifying the neural network state over one or more time increments of processing of the time-resolved frequency representation, corresponding to at least some of the number of portions of the RF signal.

2. The method of claim 1, wherein the classification output contributes to an analysis task of the RF signal.

3. The method of claim 2, wherein the classification output comprises at least one of:
modulation classification, signal-to-noise ratio (SNR) classification, or jamming detection.

4. The method of claim 2, further comprising:
detecting a jamming component in the RF signal based on the classification output; and
at least one of removing or attenuating the jamming component from the RF signal.

5. The method of claim 1, wherein transforming the at least one portion of the RF signal comprises performing a continuous wavelet transform (CWT) on the at least one portion of the RF signal.

6. The method of claim 5, wherein the CWT includes a selectable Gaussian envelope width.

7. The method of claim 6, wherein a value for the selectable Gaussian envelope width varies during processing of different portions of the RF signal.

8. The method of claim 6, further comprising selecting a value for the selectable Gaussian envelope width to favor improving time resolution of the time-resolved frequency representation over improving frequency resolution of the time-resolved frequency representation.

9. The method of claim 6, further comprising selecting a value for the selectable Gaussian envelope width to favor improving frequency resolution of the time-resolved frequency representation over improving time resolution of the time-resolved frequency representation.

10. The method of claim 1, wherein the neural network comprises a recurrent neural network (RNN).

11. The method of claim 1, wherein the classification output includes a confidence parameter that increases in confidence as the neural network performs additional time increments of processing of the time-resolved frequency representation, corresponding to processing additional portions of the RF signal.

12. The method of claim 1, comprising processing a selected number of time increments of the time-resolved frequency representation, corresponding to a partial duration of the RF signal, until at least one of: (1) a target classification accuracy is obtained; or (2) a maximum number of time increments are processed.

13. The method of claim 1, configured to provide a sub-millisecond inference latency.

14. The method of claim 13, configured to provide a sub-millisecond inference latency including using at least one of: model quantization, batch size optimization, or processor-specific optimization.

15. The method of claim 1, wherein the RF signal is received from a quantum RF sensor based on a Rydberg atom.

16. The method of claim 15, comprising deriving the time-resolved frequency representation from transitions between Rydberg energy states of the Rydberg atom.

17. The method of claim 15, wherein the RF signal comprises multiple RF tones spanning a frequency range of at least 100 GHz.

18. A system for processing a radio frequency (RF) signal, the system comprising:
one or more processors; and
a memory storing instructions that, when executed by the one or more processors, cause the system to perform operations comprising:
receiving at least one portion of an RF signal, the RF signal comprising a number of portions;
performing a continuous wavelet transform (CWT) on the at least one portion of the RF signal;
processing a CWT representation of the at least one portion of the RF signal using a recurrent neural network (RNN), wherein the RNN includes a neural network state, wherein the RNN processes the CWT representation in time increments such that the neural network state is modified at respective time increments to provide a modified neural network state that is used by the RNN in a next respective time increment; and
generating a classification output based on the RNN modifying the neural network state over one or more time increments of processing of the CWT representation, corresponding to at least some of the number of portions of the RF signal.

19. The system of claim 18, wherein the CWT includes a selectable Gaussian envelope width, wherein a value for the selectable Gaussian envelope width may be dynamically selected for processing different portions of the RF signal.

20. A non-transitory computer-readable storage medium, the non-transitory computer-readable storage medium including instructions that when executed by a processor of a system, cause the system to perform operations comprising:
receiving at least one portion of an RF signal, the RF signal comprising a number of portions;
performing a continuous wavelet transform (CWT) on the at least one portion of the RF signal, wherein the CWT includes a selectable Gaussian envelope width, wherein a value for the selectable Gaussian envelope width may be dynamically selected for processing different portions of the RF signal;
processing a CWT representation of the at least one portion of the RF signal using a recurrent neural network (RNN), wherein the RNN includes a neural network state, wherein the RNN processes the CWT representation in time increments such that the neural network state is modified at respective time increments to provide a modified neural network state that is used by the RNN in a next respective time increment; and
generating a classification output based on the RNN modifying the neural network state over one or more time increments of processing the CWT representation, corresponding to at least some of the number of portions of the RF signal.
